(19) United States
(12) Patent Application Publication
(10) Pub. No.: US 2022/0012657 A1
(43) Pub. Date: Jan. 13, 2022

(54) SCHEDULER FOR JOBS DURING OFF PEAK HOURS

(71) Applicant: salesforce.com, Inc., San Francisco, CA (US)

(72) Inventor: Sowmya Tammana, Hyderabad (IN)

(73) Assignee: salesforce.com, Inc., San Francisco, CA (US)

(21) Appl. No.: 16/946,967

(22) Filed: Jul. 13, 2020

(51) Int. Cl. G06Q 10/06; G06F 16/23; G06N 20/00

(52) U.S. Cl. CPC G06Q 10/06312; G06N 20/00; G06Q 10/06316; G06F 16/2379

(57) ABSTRACT

A method and system for scheduling jobs has been developed. A job request is received with a scheduler from a user through a user interface (UI). Job data relating to the job request is retrieved from a job database with the scheduler. The job request is assigned to a job list with the scheduler that includes job time is based on the retrieved job data. The job database is updated with the scheduler to reflect the updated job list. The job list is executed according to the assigned job time.

### TECHNICAL FIELD

Embodiments of the subject matter described herein relate generally to methods and systems for job schedule management. More particularly, embodiments of the subject matter relate to a scheduler for jobs during off peak hours.

### BACKGROUND

Job scheduling is typically based on a chronological (“cron”) expression or a simple recurring schedule with a fixed time interval. However, this may result in time periods when too many jobs are running and thus causing high wait times in queues, spikes in CPU and memory usage, etc. Consequently, it is desirable to have a scheduler for jobs during off peak hours. Furthermore, other desirable features and characteristics will become apparent from the subsequent detailed description and the appended claims, taken in conjunction with the accompanying drawings and the foregoing technical field and background.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 shows a block diagram of a smart scheduler to schedule jobs during off-peak hours in accordance with one embodiment;

FIG. 2A shows a flow chart for predicting job requirements during off-peak hours with a smart scheduler in accordance with one embodiment;

FIG. 2B shows a flow chart for building a job schedule in accordance with one embodiment;

FIG. 2C shows a flow chart for updating a job database in accordance with one embodiment; and

FIG. 3 shows an exemplary multi-tenant database system that dynamically creates and supports virtual applications based upon data from a database that may be shared between multiple tenants.

### DETAILED DESCRIPTION

A system and method for scheduling jobs during off-peak hours has been developed. First, a job request is received from a user with a scheduler through a user interface (UI). Job data relating to the job request is then retrieved from a job database with the scheduler. The job request is assigned to a job list with the scheduler that includes an assigned job time based on the retrieved job data. The job database is updated with the scheduler to reflect the updated job list. Finally, the job list is executed according to the assigned job time.

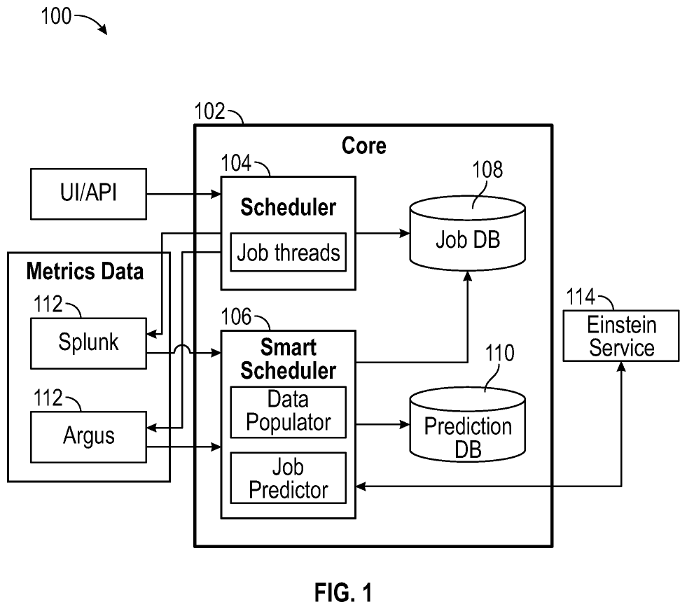

Turning now to FIG. 1, a block diagram 100 is shown a smart scheduler 106 to schedule jobs for a system 102 during off-peak hours in accordance with one embodiment. In this embodiment, the system 102 comprises a job scheduler service 104, a smart job scheduler 106, a job database 108 and a job prediction database 110. In this embodiment, the job scheduler service 104 and the smart job scheduler 106 are shown as two different components. However, the components 104 and 106 could be combined in alternative embodiments. Likewise, while the databases 108 and 110 are shown as separate components, they could be combined into a single database in alternative embodiments.

An initial job request is received by the job scheduler service 104 from a user through a user interface (UI) 111. The job may be a new job or an update to an existing job. The UI may be an application programming interface (API). Jobs may be classified as two separate types: cron based or dynamic. A “cron based” job has a specific recurring scheduled time for execution (e.g., 0900 everyday). However, a “dynamic” job only has a specific time period or window (e.g., once a day, once a week) in which the job is to be run at the services choice within the time window. Metrics and data for a job is provided by a logging service. In this example, two logging services are shown and listed as “Splunk” and “Argus” 112. These are two separate user services well known in the art. However, other suitable logging services could be used.

Once the job request is received, job data relating to the job request is retrieved from a job database 108 that is part of the system 102. The job data comprises job metadata, a previous job time for a previous similar job request from the user, and a projected job time based on the same previous similar job request. The job request is assigned to a job list or “job thread” maintained by the scheduler service 104. The metrics of this assignment are published to the logging service 112 (e.g., Splunk and Argus). The assignment to the job list is updated in the job database 108. The job list is then executed at an assigned job time. If the job is cron based, the scheduler service 104 will add the details of the job into the job database 108 with the specific date/time of when the job should be run next time.

Conversely, if the job is dynamic, the scheduler service 104 will add the details of the job into the job database 108 without a specific date/time but instead will include a time window for execution. The smart scheduler 106 updates the time windows for dynamic jobs regularly so that the scheduler service 104 can execute them within the designated time period.

In this embodiment, the smart scheduler 106 updates and uses a job prediction database 110 for the system 102. A data populator that is part of the smart scheduler 106 continually pulls information from the logging service 112 and stores the data in the job prediction database 110. A job predictor that is part of the smart scheduler 106 periodically builds a job schedule model using a machine learning or “artificial intelligence” (AI) engine 114. In this embodiment, the machine learning engine is listed as “Einstein Service” which is known in the art. However, other similar engines known to those of ordinary skill in the art could be used. The job schedule model is used to configure the job list that includes execution times during off-peak usage hours.

The off-peak usage hours are identified by the job schedule model which includes a jobless traffic prediction for future time periods. In some embodiments, these predictions are based on a time period of the next day (i.e., 24 hours). Once these lower usage times are identified for a future time period, the job list is assigned to an execution time during the lower usage time. The job database 108 is updated by the job predictor to reflect the execution time during the off-peak hours.

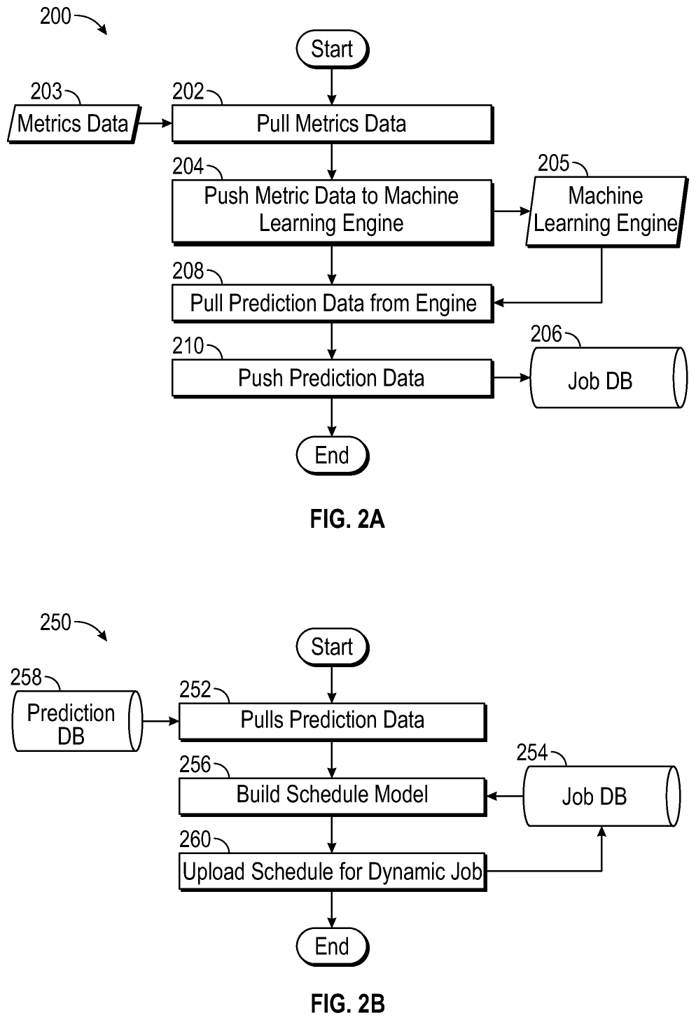

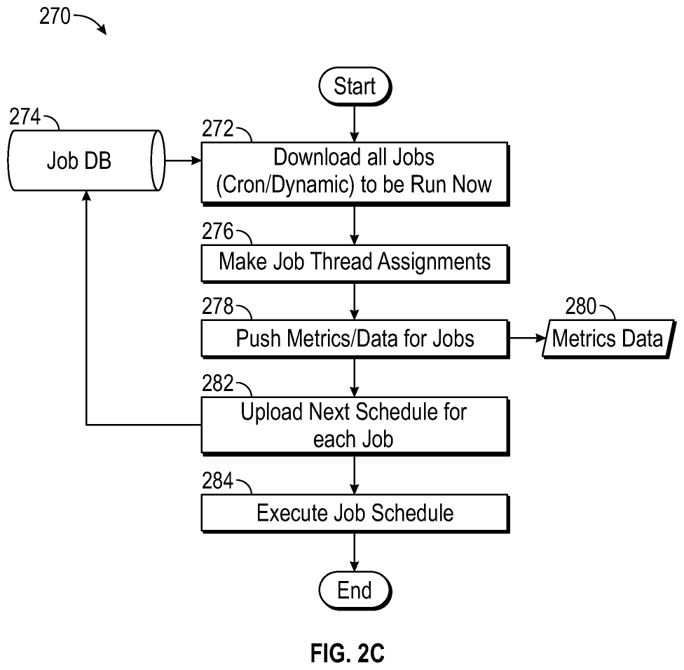

Turning now to FIG. 2A, a flowchart 200 is shown for predicting job requirements for a system during off-peak hours with a smart scheduler in accordance with one embodiment. In this method, metrics/data is pulled for a job from at least one logging service 203 by the smart scheduler 202. The metric data is pushed 204 to a machine learning engine 205 that generates prediction data that is pulled by the smart scheduler 206. The smart scheduler then pushes the job prediction data 210 to the job database 208 for storage.

Turning now to FIG. 2B, a flowchart 250 is shown for a method for building a job schedule for a system in accordance with one embodiment. In this method, a smart scheduler pulls job prediction data 252 from a prediction database 258. The prediction data is used to build a job schedule model 256 with data pulled from a job database 254. The job schedule for dynamic jobs is then uploaded 260 to the job database 254.

Turning now to FIG. 2C, a flow chart 270 is shown for updating a job database and executing a job schedule for a system in accordance with one embodiment. First, all of the jobs (both cron based and dynamic) to be run at the present time are downloaded 272 from the job database 274. Job thread assignments are made a scheduler 276 and metrics/data for the jobs are pushed 278 to a logging service 280. The next schedule for each job is uploaded 282 to the job database 274. Finally, the scheduler may execute the job schedule at the appropriate time 284.

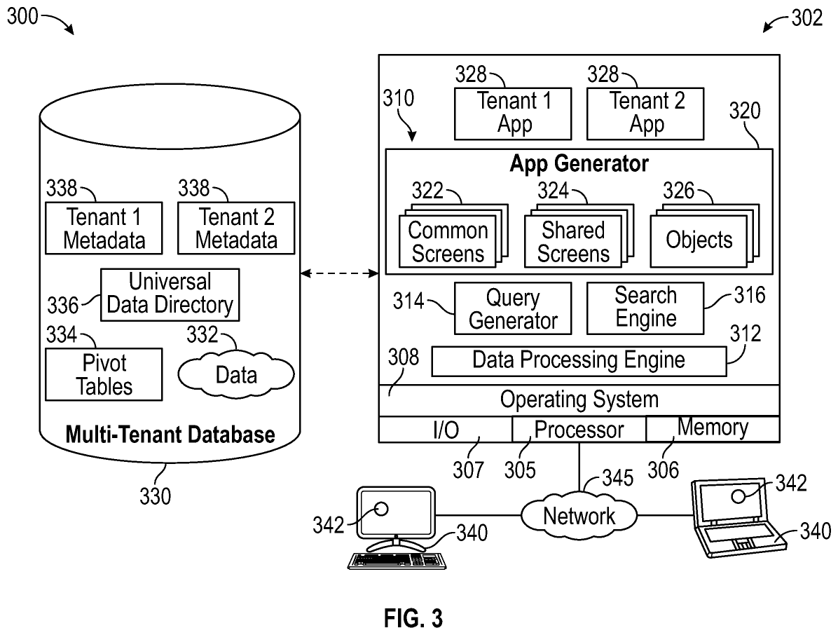

Turning now to FIG. 3, an exemplary multi-tenant system 300 includes a server 302 that dynamically creates and supports virtual applications 328 based upon data 332 from a database 330 that may be shared between multiple tenants, referred to herein as a multi-tenant database. Data and services generated by the virtual applications 328 are provided via a network 345 to any number of client devices 340, as desired. Each virtual application 328 is suitably generated at run-time (or on-demand) using a common application platform 310 that securely provides access to the data 332 in the database 330 for each of the various tenants subscribing to the multi-tenant system 300. In accordance with one non-limiting example, the multi-tenant system 300 is implemented in the form of an on-demand multi-tenant customer relationship management (CRM) system that can support any number of authenticated users of multiple tenants.

As used herein, a “tenant” or an “organization” should be understood as referring to a group of one or more users that shares access to common subset of the data within the multi-tenant database 330. In this regard, each tenant includes one or more users associated with, assigned to, or otherwise belonging to that respective tenant. Stated another way, each respective user within the multi-tenant system 300 is associated with, assigned to, or otherwise belongs to a particular one of the plurality of tenants supported by the multi-tenant system 300. Tenants may represent companies, corporate departments, business or legal organizations, and/or any other entities that maintain data for particular sets of users (such as their respective customers) within the multi-tenant system 300. Although multiple tenants may share access to the server 302 and the database 330, the particular data and services provided from the server 302 to each tenant can be securely isolated from those provided to other tenants. The multi-tenant architecture therefore allows different sets of users to share functionality and hardware resources without necessarily sharing any of the data 332 belonging to or otherwise associated with other tenants.

The multi-tenant database 330 may be a repository or other data storage system capable of storing and managing the data 332 associated with any number of tenants. The database 330 may be implemented using conventional database server hardware. In various embodiments, the database 330 shares processing hardware 304 with the server 302. In other embodiments, the database 330 is implemented using separate physical and/or virtual database server hardware that communicates with the server 302 to perform the various functions described herein. In an exemplary embodiment, the database 330 includes a database management system or other equivalent software capable of determining an optimal query plan for retrieving and providing a particular subset of the data 332 to an instance of virtual application 328 in response to a query initiated or otherwise provided by a virtual application 328, as described in greater detail below. The multi-tenant database 330 may alternatively be referred to herein as an on-demand database, in that the multi-tenant database 330 provides (or is available to provide) data at run-time to on-demand virtual applications 328 generated by the application platform 310, as described in greater detail below.

In practice, the data 332 may be organized and formatted in any manner to support the application platform 310. In various embodiments, the data 332 is suitably organized into a relatively small number of large data tables to maintain a semi-amorphous “heap”-type format. The data 332 can then be organized as needed for a particular virtual application 328. In various embodiments, conventional data relationships are established using any number of pivot tables 334 that establish indexing, uniqueness, relationships between entities, and/or other aspects of conventional database organization as desired. Further data manipulation and report formatting is generally performed at run-time using a variety of metadata constructs. Metadata within a universal data directory (UDD) 336, for example, can be used to describe any number of forms, reports, workflows, user access privileges, business logic and other constructs that are common to multiple tenants. Tenant-specific formatting, functions and other constructs may be maintained as tenant-specific metadata 338 for each tenant, as desired. Rather than forcing the data 332 into an inflexible global structure that is common to all tenants and applications, the database 330 is organized to be relatively amorphous, with the pivot tables 334 and the metadata 338 providing additional structure on an as-needed basis. To that end, the application platform 310 suitably uses the pivot tables 334 and/or the metadata 338 to generate “virtual” components of the virtual applications 328 to logically obtain, process, and present the relatively amorphous data 332 from the database 330.

The server 302 may be implemented using one or more actual and/or virtual computing systems that collectively provide the dynamic application platform 310 for generating the virtual applications 328. For example, the server 302 may be implemented using a cluster of actual and/or virtual servers operating in conjunction with each other, typically in association with conventional network communications, cluster management, load balancing and other features as appropriate. The server 302 operates with any sort of conventional processing hardware 304, such as a processor 305, memory 306, input/output features 307 and the like. The input/output features 307 generally represent the interface(s) to networks (e.g., to the network 345, or any other local area, wide area or other network), mass storage, display devices, data entry devices and/or the like. The processor 305 may be implemented using any suitable processing system, such as one or more processors, controllers, microprocessors, microcontrollers, processing cores and/or other computing resources spread across any number of distributed or integrated systems, including any number of “cloud-based” or other virtual systems. The memory 306 represents any non-transitory short or long term storage or other computer-readable media capable of storing programming instructions for execution on the processor 305, including any sort of random access memory (RAM), read only memory (ROM), flash memory, magnetic or optical mass storage, and/or the like. The computer-executable programming instructions, when read and executed by the server 302 and/or processor 305, cause the server 302 and/or processor 305 to create, generate, or otherwise facilitate the application platform 310 and/or virtual applications 328 and perform one or more additional tasks, operations, functions, and/or processes described herein. It should be noted that the memory 306 represents one suitable implementation of such computer-readable media, and alternatively or additionally, the server 302 could receive and cooperate with external computer-readable media that is realized as a portable or mobile component or platform, e.g., a portable hard drive, a USB flash drive, an optical disc, or the like.

The application platform 310 is any sort of software application or other data processing engine that generates the virtual applications 328 that provide data and/or services to the client devices 340. In a typical embodiment, the application platform 310 gains access to processing resources, communications interfaces and other features of the processing hardware 304 using any sort of conventional or proprietary operating system 308. The virtual applications 328 are typically generated at run-time in response to input received from the client devices 340. For the illustrated embodiment, the application platform 310 includes a bulk data processing engine 312, a query generator 314, a search engine 316 that provides text indexing and other search functionality, and a runtime application generator 320. Each of these features may be implemented as a separate process or other module, and many equivalent embodiments could include different and/or additional features, components or other modules as desired.

The runtime application generator 320 dynamically builds and executes the virtual applications 328 in response to specific requests received from the client devices 340. The virtual applications 328 are typically constructed in accordance with the tenant-specific metadata 338, which describes the particular tables, reports, interfaces and/or other features of the particular application 328. In various embodiments, each virtual application 328 generates dynamic web content that can be served to a browser or other client program 342 associated with its client device 340, as appropriate.

The runtime application generator 320 suitably interacts with the query generator 314 to efficiently obtain multi-tenant data 332 from the database 330 as needed in response to input queries initiated or otherwise provided by users of the client devices 340. In a typical embodiment, the query generator 314 considers the identity of the user requesting a particular function (along with the user's associated tenant), and then builds and executes queries to the database 330 using system-wide metadata 336, tenant specific metadata 338, pivot tables 334, and/or any other available resources. The query generator 314 in this example therefore maintains security of the common database 330 by ensuring that queries are consistent with access privileges granted to the user and/or tenant that initiated the request.

With continued reference to FIG. 3, the data processing engine 312 performs bulk processing operations on the data 332 such as uploads or downloads, updates, online transaction processing, and/or the like. In many embodiments, less urgent bulk processing of the data 332 can be scheduled to occur as processing resources become available, thereby giving priority to more urgent data processing by the query generator 314, the search engine 316, the virtual applications 328, etc.

In exemplary embodiments, the application platform 310 is utilized to create and/or generate data-driven virtual applications 328 for the tenants that they support. Such virtual applications 328 may make use of interface features such as custom (or tenant-specific) screens 324, standard (or universal) screens 322 or the like. Any number of custom and/or standard objects 326 may also be available for integration into tenant-developed virtual applications 328. As used herein, “custom” should be understood as meaning that a respective object or application is tenant-specific (e.g., only available to users associated with a particular tenant in the multi-tenant system) or user-specific (e.g., only available to a particular subset of users within the multi-tenant system), whereas “standard” or “universal” applications or objects are available across multiple tenants in the multi-tenant system. The data 332 associated with each virtual application 328 is provided to the database 330, as appropriate, and stored until it is requested or is otherwise needed, along with the metadata 338 that describes the particular features (e.g., reports, tables, functions, objects, fields, formulas, code, etc.) of that particular virtual application 328. For example, a virtual application 328 may include a number of objects 326 accessible to a tenant, wherein for each object 326 accessible to the tenant, information pertaining to its object type along with values for various fields associated with that respective object type are maintained as metadata 338 in the database 330. In this regard, the object type defines the structure (e.g., the formatting, functions and other constructs) of each respective object 326 and the various fields associated therewith.

Still referring to FIG. 3, the data and services provided by the server 302 can be retrieved using any sort of personal computer, mobile telephone, tablet or other network-enabled client device 340 on the network 345. In an exemplary embodiment, the client device 340 includes a display device, such as a monitor, screen, or another conventional electronic display capable of graphically presenting data and/or information retrieved from the multi-tenant database 330, as described in greater detail below. Typically, the user operates a conventional browser application or other client program 342 executed by the client device 340 to contact the server 302 via the network 345 using a networking protocol, such as the hypertext transport protocol (HTTP) or the like. The user typically authenticates his or her identity to the server 302 to obtain a session identifier (“SessionID”) that identifies the user in subsequent communications with the server 302. When the identified user requests access to a virtual application 328, the runtime application generator 320 suitably creates the application at run time based upon the metadata 338, as appropriate. As noted above, the virtual application 328 may contain Java, ActiveX, or other content that can be presented using conventional client software running on the client device 340; other embodiments may simply provide dynamic web or other content that can be presented and viewed by the user, as desired. As described in greater detail below, the query generator 314 suitably obtains the requested subsets of data 332 from the database 330 as needed to populate the tables, reports or other features of the particular virtual application 328.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

“Node/Port”—As used herein, a “node” means any internal or external reference point, connection point, junction, signal line, conductive element, or the like, at which a given signal, logic level, voltage, data pattern, current, or quantity is present. Furthermore, two or more nodes may be realized by one physical element (and two or more signals can be multiplexed, modulated, or otherwise distinguished even though received or output at a common node). As used herein, a “port” means a node that is externally accessible via, for example, a physical connector, an input or output pin, a test probe, a bonding pad, or the like.

“Connected/Coupled”—The following description refers to elements or nodes or features being “connected” or “coupled” together. As used herein, unless expressly stated otherwise, “coupled” means that one element/node/feature is directly or indirectly joined to (or directly or indirectly communicates with) another element/node/feature, and not necessarily mechanically. Likewise, unless expressly stated otherwise, “connected” means that one element/node/feature is directly joined to (or directly communicates with) another element/node/feature, and not necessarily mechanically. Thus, although the schematic shown in FIG. 3 depicts one exemplary arrangement of elements, additional intervening elements, devices, features, or components may be present in an embodiment of the depicted subject matter.

In addition, certain terminology may also be used in the following description for the purpose of reference only, and thus are not intended to be limiting. For example, terms such as “upper”, “lower”, “above”, and “below” refer to directions in the drawings to which reference is made. Terms such as “front”, “back”, “rear”, “side”, “outboard”, and “inboard” describe the orientation and/or location of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second”, and other such numerical terms referring to structures do not imply a sequence or order unless clearly indicated by the context.

For the sake of brevity, conventional techniques related to signal processing, data transmission, signaling, network control, and other functional aspects of the systems (and the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in an embodiment of the subject matter.

The various tasks performed in connection with the process may be performed by software, hardware, firmware, or any combination thereof. For illustrative purposes, the description of the process may refer to elements mentioned above. In practice, portions of the process may be performed by different elements of the described system, e.g., component A, component B, or component C. It should be appreciated that process may include any number of additional or alternative tasks, the tasks shown need not be performed in the illustrated order, and the process may be incorporated into a more comprehensive procedure or process having additional functionality not described in detail herein. Moreover, one or more of the tasks could be omitted from an embodiment of the process as long as the intended overall functionality remains intact.

The foregoing detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, or detailed description.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for scheduling jobs, comprising:
receiving a job request with a scheduler from a user through a user interface (UI);
retrieving job data relating to the job request from a job database with the scheduler;
assigning the job request to a job list with the scheduler, where a job time is assigned to the job list based on the retrieved job data;
updating the job database with the scheduler to reflect the updated job list; and
executing the job list upon reaching the assigned job time.

2. The method of claim 1, where the UI comprises an application program interface (API).

3. The method of claim 1, where the job data comprises metadata from the job request.

4. The method of claim 1, where the job data comprises a previous job time for a previous similar job request from the user.

5. The method of claim 1, where the job data comprises a predicted job time based on a previous similar job request from the user.

6. The method of claim 1, where the job database is continually polled by the scheduler to update the job list.

7. A method for maintaining a job prediction database for a system, comprising:
retrieving job prediction data from a prediction database with a data populator;
building a job schedule model for dynamic jobs with a scheduler based on the job prediction data that is retrieved from a job database, where the job schedule model includes execution time periods for the dynamic jobs; and
updating the job database with the job schedule model for dynamic jobs.

8. The method of claim 7, where the data populator continually polls job data from a logging service to update the job prediction database.

9. The method of claim 7, where the job schedule model includes job list traffic predictions for a future time period.

10. The method of claim 9, where the future time period is 24 hours.

11. The method of claim 9, where the job schedule model identifies lower usage times during the future time period according to the job list traffic predictions.

12. The method of claim 11, further comprising:
assigning the job list and execution time period during an identified lower usage time.

13. The method of claim 12, further comprising:
updating the job database with the job predictor to reflect the execution time period during an identified lower usage time.

14. The method of claim 7, where the job data comprises metadata from the job request.

15. The method of claim 7, where the job data comprises a previous job time for a previous similar job request from the user.

16. The method of claim 7, where the job data comprises a predicted job time based on a previous similar job request from the user.
